(19) United States
(12) Patent Application Publication
(10) Pub. No.: US 2019/0261580 A1
(43) Pub. Date: Aug. 29, 2019

(54) COMPOSITIONS FOR CONTROLLING WEEDS GROWING

(71) Applicants: Ron COHEN, Kfar Azar (IL); Yehonatan ANTEBI, Herzeliya (IL)

(72) Inventors: Ron COHEN, Kfar Azar (IL); Yehonatan ANTEBI, Herzeliya (IL)

(21) Appl. No.: 16/341,181

(22) PCT Filed: Oct. 3, 2017
(86) PCT No.: PCT/IL2017/051124

§ 371 Date: Apr. 11, 2019

Related U.S. Application Data
(60) Provisional application No. 62/407,601, filed on Oct. 13, 2016.

(51) Int. Cl. A01G 13/02; C08J 9/236

(52) U.S. Cl. CPC A01G 13/0281; C08G 2101/0008; C08J 9/236

(57) ABSTRACT

A composite characterized by an average density of 60 Kg/m³ to 180 Kg/m³, with at least two portions having a different density of at least 20 Kg/m³, made of a binder, and a foamed elastomer or a foamed rigid polymer, is disclosed herein. Uses of the composite and of matrices and articles incorporating same for the improvement of plant growing and/or weed control are further disclosed.

### CROSS-REFERENCE TO RELATED APPLICATIONS

This application claims the benefit of priority from U.S. Provisional Patent Application No. 62/407,601, filed on Oct. 13, 2016. The content of the above document is incorporated by reference in its entirety as if fully set forth herein.

### FIELD OF THE INVENTION

The present invention, in some embodiments thereof, relates to composites, matrices, and articles comprising same for the improvement of plant growing and weed control.

### BACKGROUND OF THE INVENTION

In order to beautify grounds, natural mulching systems, such as natural bark, wood products, peat, etc. have been used to mulch around trees, plants and other items. These inhibit weed and grass growth and present a manicured appearance, but require continual care and replenishment.

The use of weed poisons, in addition to purely mechanical methods, has been the dominating method for weed control. However, there is increasing concern that an extensive use of weed poisons may harm the environment as well as humans and animals.

In considering use of phase separation systems particularly around trees and plants, it is important to inhibit near weed and grass growth to eliminate the need for close-in trimming and mowing, but at the same time to protect and accommodate the underlying root system, and to present a desired aesthetic appearance. Yet, in some cases, these phase separation systems might cause more harm than good as they tend to fail to allow air and water permeability or fail to effectively prevent weed growth.

### SUMMARY OF THE INVENTION

The present invention, in some embodiments thereof, relates to composites, matrices and articles comprising same for agricultural uses e.g., weed control.

According to an aspect of some embodiments of the present invention there is provided a matrix comprising a composite having a plurality of portions, wherein: the plurality of portions comprises a polymer selected from the group consisting of: a foamed elastomer, and a foamed rigid polymer; a binder; the composite is characterized by an average density of from 60 Kg/m³ to 180 Kg/m³, and at least two portions of the plurality of portions differ in density by at least 20 Kg/m³.

In some embodiments, the plurality of portions are made of different polymers.

In some embodiments, the matrix (or the composite) is in the form of a multi-laminar structure.

In some embodiments, the binder comprises a polymer selected from the group consisting of: polyepoxide, polyester, polyurethane (PU), a silicone adhesive, or any combination thereof.

In some embodiments, the PU comprises one or more monomeric units selected from the group consisting of: methylene diphenyl diisocyanate (MDI), toluene diisocyanate (TDI), or any combination thereof.

In some embodiments, the foamed elastomer is selected from the group consisting of: PU, cross-linked polyethylene (XPE), foamed polyethylene (PE), ethylene vinyl acetate (EVA), styrene-butadiene rubber (SBR), polyethylene terephthalate (PET), polyvinyl chloride (PVC), silicone foam, or a combination thereof.

In some embodiments, the binder is present at about 7% to 15%, by weight of the composite.

In some embodiments, the foamed elastomer is selected from the group consisting of: polyurethane (PU), cross-linked polyethylene (XPE), foamed polyethylene (PE), ethylene vinyl acetate (EVA), styrene-butadiene rubber (SBR), polyethylene terephthalate (PET), polyvinyl chloride (PVC), silicone foam, or a combination thereof.

In some embodiments, the foamed rigid polymer comprises a polymer selected from the group consisting of: polystyrene, polypropylene (PP), PE, PU, rigid PVC, or a combination thereof.

In some embodiments, the polystyrene is in the form selected from the group consisting of: expandable polystyrene (EPS), extruded polystyrene (XPS), or a combination thereof.

In some embodiments, the adhesive comprises a polymer selected from the group consisting of: polyepoxide, polyester, PU, a silicone adhesive, or a combination thereof.

In some embodiments, the foamed elastomer, and the foamed rigid polymer are, together, at least 60%, by weight, of the matrix.

In some embodiments, at least 60% of the foamed elastomer and the rigid polymer is in the form of open-cell foam.

In some embodiments, the matrix (or the composite) further comprises one or more materials selected from the group consisting of: a pesticide, an herbicide, a fertilizer, a fungicide, a plant hormone, or any combination thereof.

In some embodiments, the matrix (or the composite) is characterized by light transmittance of less than 10% per cm thickness.

In some embodiments, the matrix (or the composite) is characterized by compression load deflection (CLD) hardness at 50% deflection of from about 10 kPa to about 150 kPa.

In some embodiments, the matrix (or the composite) is characterized by water permeability of about 0.1 to about 0.5 ml/cm/min.

According to an aspect of some embodiments of the present invention there is provided an article or a kit comprising the disclosed matrix in some embodiments thereof. In some embodiments, the matrix is in a unitary form of a cover or a mulch pad. In some embodiments, the cover is a rectangle- or disc-shaped cover.

In some embodiments, at least one surface of the article is configured to contact soil around or between objects. In some embodiments, the object is a plant.

In some embodiments, the article is configured to reduce a temperature of a soil by 5° C. to 15° C., at an outside air temperature of 25° C. to 40° C. (e.g., about 30° C.), compared to a situation lacking the presence of the article.

In some embodiments, the disclosed article or kit, is for use in a method for preventing growth of grass and/or weeds. In some embodiments, the composite is characterized by a thickness that ranges from 0.1 cm to 10 cm along a peripheral edge of the disc or the mulch pad, wherein the thickness varies within a range of less than ±10%.

In some embodiments, the disclosed article or kit, further comprises a radial cut extended through the thickness of the matrix, configured to decrease the circumference of the article.

In some embodiments, the circumference is dynamically adaptable, allowing to provide adjustable disc-shaped cover.

In some embodiments, the adjustable disc-shaped cover allows one side of the cut to overlay the other side of the cut.

In some embodiments, the cut allows deforming a disc-shaped cover to a cone- or concave-shaped cover.

In some embodiments, the disclosed article or kit, further comprises an instruction sheet, or a label.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents a photograph showing the disclosed cover (paced on pots) as described in some embodiments of the present invention.

FIGS. 2A-B present photographs comparatively demonstrating the growth of weeds (marked by circles) with (FIG. 2A) and without (FIG. 2B) the use of the disclosed cover (paced on pots) as described in some embodiments of the present invention.

FIG. 3 presents comparison graphs showing the results of water saving experiments using the disclosed disc, vis-à-vis coco disc and control (no disc).

FIG. 4 presents a photograph showing the difference in plant growth rate with (left) and without (right) the use of the disclosed cover (paced on pots).

FIGS. 5A-B present schemes (side view, FIG. 5A; and top view, FIG. 5B) of the disclosed cover, in some embodiments thereof, having a notch or a cut (full line) allowing one region of the disc to overlay another region of the disc, thereby providing a controllable thickness and density of the cover; dotted line points the position of the overlay layer, relocated in the direction relative to the original position, as marked by arrow).

FIGS. 6A-E present photographs showing various shapes of the disclosed cover (placed on pots) as described in some embodiments of the present invention: bowl shape cone-(FIG. 6A); desert cone- (FIG. 6B); semi concave- (FIG. 6C), and cone shape- (FIG. 6D and FIG. 6E) covers.

### DETAILED DESCRIPTION OF THE INVENTION

The present invention, in some embodiments thereof, relates to composites, matrices and articles comprising same, for agricultural uses e.g., weed control.

The present inventors have developed a two-component composite (e.g., adhesive & foam). The composite, in some embodiments thereof, is characterized by a foamy open cell structure and by desired mechanical and physical properties.

The disclosed composites, matrices and articles may be utilized e.g., as planting pot coverage disc allowing to save labor time in weed control, to improve growth climate conditions and to eliminate the need of using hazardous chemicals.

The disclosed cover may be for use with plants in different sized containers and are capable of retaining moisture in the soil and dispensing plant-useful material to the soil, is characterized by low light transmittance (e.g., less than 20% per cm thickness) while permitting the passage of air.

As described in the Examples section hereinbelow, the disclosed composites may allow to prolong the time between irrigations (e.g., of both water and fertilization).

A person skilled in the art would readily recognize that prolonging the span of time between irrigations may be further affected by the type of the plant, the outside air temperature, the type of the soil, e.g., the soil texture, etc.).

As described hereinbelow, in some embodiments, the disclosed composites and articles are highly flexible and formable allowing to use thereof for various sized plants, and to fit various sizes and shapes of pots around various stem locations.

Before explaining further embodiments of the invention in detail, it is to be understood that the invention is not necessarily limited in its application to the details set forth hereinthroughout or exemplified by the Examples. The invention is capable of other embodiments or of being practiced or carried out in various ways.

According to an aspect of some embodiments of the present invention there is provided a matrix comprising a composite having a plurality of portions, wherein the plurality of portions comprises a polymer selected from a foamed elastomer, and a foamed rigid polymer; the composite being characterized by an average density of from 50 Kg/m³ to 300 Kg/m³, wherein at least two portions of said plurality of portions differ in density by at least 5 Kg/m³ (e.g., from 5 Kg/m³ to 50 Kg/m³). In some embodiments the composite further comprises a binder (adhesive).

Embodiments of the “plurality of portions” are described hereinbelow. In some embodiments of the present invention there is provided a matrix comprising the composite having the plurality of portions.

In some embodiments, at least one of the plurality of portions comprises a polymer selected from a foamed elastomer, and at least one of the plurality of portions comprises a rigid polymer.

In some embodiments, the term “portion” refers to a volume of a region or a part of the composite, e.g., 0.1 mm³, 0.5 mm³, 1 mm³, 1.5 mm³, 2 mm³, 2.5 mm³, 3 mm³, 3.5 mm³, 4 mm³, 4.5 mm³, 5 mm³, 5.5 mm³, 6 mm³, 6.5 mm³, 7 mm³, 7.5 mm³, 8 mm³, 8.5 mm³, 9 mm³, 10 mm³, 15 mm³, 20 mm³, 25 mm³, 30 mm³, 35 mm³, 40 mm³, 45 mm³, 50 mm³, 55 mm³, 60 mm³, 65 mm³, 70 mm³, 75 mm³, 80 mm³, 85 mm³, 90 mm³, 95 mm³, 100 mm³, 200 mm³, 300 mm³, 400 mm³, 500 mm³, 600 mm³, 700 mm³, 800 mm³, 900 mm³, or 1000 mm³, including any value and range therebetween.

As used herein, the term “matrix” encompasses solid substrates, including solid particles or solid phases.

In some embodiments, the term “composite” refers to a material which is composed of two or more substances having different characteristics and in which each substance retains its identity while contributing desirable properties to the whole.

In some embodiments, the matrix is two-dimensional. In some embodiments, the matrix has a three-dimensional framework.

As used hereinthroughout, the term “polymer” describes an organic substance composed of a plurality of repeating structural units (also referred to as: “monomeric unit” or “backbone units”) covalently connected to one another.

The term “polymer” includes, but is not limited to, homopolymers, copolymers, such as, for example, block-, graft-, random- and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries. The polymers disclosed herein can be block polymers which comprise, on the one hand, at least one water-soluble or water-dispersible polymer block and, on the other hand, at least one hydrophobic block.

The term “block copolymer” may refer to copolymers wherein monomeric units of a given type are organized in blocks, i.e. monomeric units of the same type are adjacent to each other. To explain further, the term “block copolymer” may include molecules of the type AᵢBⱼAₖBₗ, wherein A and B designate distinct types of monomers and the indices i, j, k and l are integer numbers such that at least two, or at least three of them have a value of at least 1.

In some embodiments, the composite is characterized by an average density of from 50 kg/m³ to 300 kg/m³. In some embodiments, the composite is characterized by an average density of from 60 kg/m³ to 250 kg/m³. In some embodiments, the composite is characterized by an average density of from 70 kg/m³ to 200 kg/m³. In some embodiments, the composite is characterized by an average density of from 80 kg/m³ to 150 kg/m³. In some embodiments, the composite is characterized by an average density of from 100 kg/m³ to 130 kg/m³. In some embodiments, the composite is characterized by an average density of from 100 kg/m³ to 120 kg/m³.

In some embodiments, the composite is characterized by an average density of 50 kg/m³, 60 kg/m³, 70 kg/m³, 80 kg/m³, 90 kg/m³, 100 kg/m³, 110 kg/m³, 120 kg/m³, 130 kg/m³, 140 kg/m³, 150 kg/m³, 160 kg/m³, 170 kg/m³, 180 kg/m³, 190 kg/m³, 200 kg/m³, 210 kg/m³, 220 kg/m³, 230 kg/m³, 240 kg/m³, 250 kg/m³, 260 kg/m³, 270 kg/m³, 280 kg/m³, 290 kg/m³, or 300 kg/m³, including any value and range therebetween.

In some embodiments, at least two of the plurality of portions differ in density by at least 5 kg/m³, at least 10 kg/m³, at least 15 kg/m³, at least 20 kg/m³, at least 30 kg/m³, at least 35 kg/m³, at least 40 kg/m³, at least 45 kg/m³, or at least 50 kg/m³, including any value and range therebetween.

By “a portion thereof”, or by “portion(s)”, it is meant, for example, a surface or a portion thereof, and/or a body or a portion thereof, or a volume or a part thereof.

As used herein and in the art, the term “elastomer” indicates a polymeric material that exhibits a combination of high elongation or extensibility, high retractability to its original shape or dimensions after removal of the stress or load with little or no plastic deformation as well as material that possesses low modulus and requires a low load to be stretched.

In some embodiments, the composite is characterized by tensile strength (as performed by ISO 1798) of 20 kPa, 25 kPa, 30 kPa, 35 kPa, 40 kPa, 45 kPa, 50 kPa, 55 kPa, 60 kPa, 65 kPa, 70 kPa, 75 kPa, 80 kPa, 85 kPa, 90 kPa, 95 kPa, 100 kPa, 115 kPa, 120 kPa, 125 kPa, 130 kPa, 135 kPa, 140 kPa, 145 kPa, 150 kPa, 155 kPa, 160 kPa, 165 kPa, 170 kPa, 175 kPa, 180 kPa, 185 kPa, 190 kPa, 195 kPa, or 200 kPa, including any value and range therebetween.

In some embodiments, the term “foam” refers to rebond foam.

As used herein throughout, the term “rebond foam” is intended to mean a foam comprising a plurality of foam pieces which have been bonded together e.g., with a binder or adhesive to produce an integral body.

Specifically, it has been discovered that notwithstanding the process used to produce the rebond foam, a specified resulting rebond foam possesses allows to provide the desired properties or uses as described hereinthroughout.

Typically, but not exclusively, foamed elastomeric compositions are prepared by mixing a foamable, crosslinked elastomeric polymer with a cross linked and/or a blowing agent which, upon exposure to elevated temperature conditions or a chemical reaction process, decomposes to form gaseous decomposition products for expansion of the polymeric material.

Non-limiting examples of foamed elastomer are selected from polyurethane (PU or PUR), cross-linked polyethylene (XPE), foamed polyethylene (PE), ethylene vinyl acetate (EVA) or a polymer thereof, styrene-butadiene rubber (SBR), polyethylene terephthalate (PET), polyvinyl chloride (PVC), silicone foam, or any combination thereof.

The term “rigid polymer” is used herein to refer to any structural polymer suitable for forming a portion of the disclosed composite, and which is less flexible than the elastomer used.

In some embodiments, the term “rigid polymer” refers to rigid foam polymer. In some embodiments, the term “rigid foam polymer” refers to an open-cell foam of the rigid polymer. In some embodiments, by “open-cell foam of the rigid polymer” it is meant to refer to rigid polymer(s) wherein at least e.g., 20%, 30%, 40%, 50%, 60%, 70%, or 80% of the rigid polymer(s) is characterized by an open-cell foam.

Non-limiting examples of a suitable rigid foam polymer include polystyrene, polyethylene (PE) (e.g., high density PE) and polypropylene (PP), or their combination.

In some embodiments, the foamed elastomer, and the foamed rigid polymer are, together, at least 40%, at least 50%, at least 60%, at least 70%, or at least 80%, by weight, of the matrix.

In some embodiments, the polystyrene is in the form of expandable polystyrene (EPS). In some embodiments, the polystyrene is in the form of extruded polystyrene (XPS).

In some embodiments, the polystyrene is in the form of expandable and extruded polystyrene.

The term “expandable” refers hereinthroughout to the capability of the polymer to increase its volumetric dimension.

In some embodiments, the term “extruded” refers herein to a process by which a heated polymer is forced through one or more orifices or slots of a die to form a molten stream.

In some embodiments, one or more portions of the composite are cured or cross-linked.

As used herein, the term “adhesive” (when used as a noun) refers to a polymer or a composition (e.g., a composition comprising the polymer described herein, and optionally consisting of the polymer) which is capable of adhering to agents (e.g., solid and/or semi-solid agents) and/or of binding two such agents together. The terms “adhesive” and “binder” are used hereinthroughout interchangeably.

In some embodiments, the terms “curing” or “cross-linking”, or any grammatical derivative thereof, refer to a process (e.g., a chemical reaction) which allows, inter alia, increasing the mechanical strength properties of the matrix and the durability of the incorporation of the adhesive to the polymeric network.

Exemplary adhesives are selected from, but are not limited to, polyepoxide, polyester, silicone, PU, or any combination thereof.

In some embodiments, the adhesive is about 5% to 20%, by weight, of the composite. In some embodiments, the adhesive is about 8% to 15%, by weight, of the composite. In some embodiments, the adhesive is about 8% to 12%, by weight, of the composite.

In some embodiments, the adhesive is about 5%, 6%, 7%, 8%, 9%, 10%, 11%, 12%, 13%, 14%, 15%, 16%, 17%, 18%, 19%, or 20%, by weight, of the composite, including any value and range therebetween.

In some embodiments, adhesive polyurethane is a polymer formed by reacting a di- or polyisocyanate with a polyol. Both the isocyanates and polyols may be used to make polyurethanes containing, on average, two or more functional groups per molecule.

In some embodiments, the term “isocyanate” refers to e.g., aromatic, aliphatic, or isocyanates e.g., cycloaliphatic isocyanates.

Non-limiting examples of isocyanates are selected from hexamethylene diisocyanate, isophorone diisocyanate, toluene diisocyanate (TDI), methylene diphenyl diisocyanate (MDI), meta-tetramethylxylylene diisocyanate and the like. Adducts or oligomers of the diisocyanates are also suitable such as, without limitation, polymeric methylene diphenyl diisocyanate, biuret, isocyanurate trimer resins of hexamethylene diisocyanate, or isophorone diisocyanate.

In some embodiments, the foamed elastomer is in the form of an open-cell foam.

In some embodiments, the term “open-celled foam” refers to a foam layer whose cells interconnect, or otherwise create pores from one surface of the layer to the opposite surface.

By “whose cells interconnect foam layer whose cells interconnect, or otherwise create pores from one surface of the layer to the opposite surface” it means that at least e.g., 50%, 60%, 70%, 80%, 90%, or 95% of the foam layers interconnect to another layer's cell or create pores from one surface of the layer to the opposite surface.

In some embodiments, open-celled foam may allow water and/or air (e.g., at least 50%) to permeate therethrough. In some embodiments, open-celled foam may prevent (e.g., at least 80%) light rays transmittance, as described below.

Hereinthroughout, by “water” it is meant to further refer to other liquids or e.g., aqueous solution.

In some embodiments, the composite is in the form of multi-laminar structure.

As used herein, the term “multi-laminar” is intended to include, without being limited thereto, composites constructed of more than one lamina or portion, where at least two of the lamina are constructed of different materials. In some embodiments, the lamina are bonded to one another or otherwise aligned with one another so as to form a single composite (e.g., in the form of a sheet or a disc).

By “more than one lamina” it is meant to refer to at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, or at least 20 lamina (also referred to as “coverage portions” or “portions”) per cm³.

In some embodiments, the term “different materials” (or “different polymers”) is meant to refer to chemically or structurally different, or materials that have different performance characteristics e.g., difference in densities of at least 10 kg/m³. In some embodiments, the term “different materials” refers to a different (e.g., at least ±10%) path or rate of air flow therethrough.

In some embodiments, the term “different materials” (or “different polymers”) refers to chemical structures that are not exactly the same (e.g., in density), although these materials belong to the same chemical family or genus of polymers.

In some embodiments, the matrix further comprises or incorporates therein one or more materials selected from, without being limited thereto, a pesticide, an insecticide, an acaracide, a fungicide, a bactericide, an herbicide, an antibiotic, an antimicrobial, a nemacide, a rodenticide, an entomopathogen, a pheromone, an attractant, a plant growth regulator, a plant hormone, an insect growth regulator, a chemosterilant, a microbial pest control agent, a repellent, an anti-viral agent, a phagostimulent, a plant nutrient, a plant fertilizer and a biological control, or any combination thereof.

Examples of fungicides include but are not limited to the following classes of fungicides: carboxamides, benzimidazoles, triazoles, hydroxypyridines, dicarboxamides, phenylamides, thiadiazoles, carbamates, cyano-oximes, cinnamic acid derivatives, morpholines, imidazoles, beta-methoxy acrylates and pyridines/pyrimidines. Further examples of fungicides include but are not limited to natural fungicides, organic fungicides, sulfur-based fungicides, copper/calcium fungicides and elicitors of plant host defenses.

Examples of natural fungicides include, but are not limited to, whole milk, whey, fatty acids or esterified fatty acids. Examples of organic fungicides include but are not limited to any fungicide which passes an organic certification standard such as biocontrol agents, natural products, elicitors (some of may also be classed as natural products), and sulfur and copper fungicides (limited to restricted use). In some embodiments non-organic fungicides may be employed.

Examples of pesticides include, but are not limited to, azoxystrobin, bitertanol, carboxin, cymoxanil, cyproconazole, cyprodinil, dichlofluamid, difenoconazole, diniconazole, epoxiconazole, fenpiclonil, fludioxonil, fluquiconazole, flusilazole, flutriafol, furalaxyl, guazatin, hexaconazole, hymexazol, imazalil, imibenconazole, ipconazole, kresoxim-methyl, mancozeb, metalaxyl, R-metalaxyl, metconazole, oxadixyl, pefurazoate, penconazole, pencycuron, prochloraz, propiconazole, pyroquilone, SSF-109, spiroxamin, tebuconazole, thiabendazole, tolifluamid, triazoxide, triadimefon, triadimenol, triflumizole, triticonazole and uniconazole.

Further Specific examples of agricultural agents are known to those skilled in the art, and many are readily commercially available. In some embodiments, the concentration at which these materials are to be incorporated in the disclosed matrix (e.g., so as to serve as effective biological control agents) may vary depending on the end use.

In some embodiments, by “end use” it is meant to refer to the context of plant type, or plant treatment, including, for example, physiological condition of the plant; type (including bacterial species), concentration and degree of pathogen infection; temperature, season, humidity, stage in the growing season and the age of plant; number and type of conventional pesticides, or other treatments (including fungicides) being applied.

In some embodiments, the composite is characterized by light transmittance of less than 20% per cm thickness. In some embodiments, the composite is characterized by light transmittance of less than 10% per cm thickness. In some embodiments, the composite is characterized by light transmittance of less than 5% per cm thickness.

The term “light transmittance” refers to the amount or percentage of light intensity that passes through a sample. Light transmittance measurements can be made e.g., by spectrophotometers or using light absorption sensor.

In some embodiments, light transmittance is measured by irradiating light having a wavelength of e.g., from about 300 nm to about 900 nm, or in some embodiments, from 400 nm to 800 nm.

As noted hereinabove, in some embodiments, the composite is characterized by an open-cell foamed structure. Open-cell foamed structure may allow a desired path for air, thereby providing the plant e.g., gases that are necessary for plant growth.

As characterized in the Examples section that follows, in some embodiments, the composite varying in densities in different portions thereof as described above is characterized by reduced water uptake thereby allowing e.g., to prolong the time duration (e.g., by 100%, 200%, 300%, or 400%, per 1 cm thickness, including any value therebetween) between irrigations of the covered plant.

In some embodiments, the disclosed matrix is characterized by water permeability of about 0.01 to about 1 ml/cm/min, about 0.05 to about 0.5 ml/cm/min, about 0.05 to about 0.5 ml/cm/min, about 0.1 to about 0.5 ml/cm/min, or about 0.2 to about 0.4 ml/cm/min.

In some embodiments, the composite is characterized by withstanding tensile force of 50 Newton, 100 Newton, 150 Newton, 200 Newton, 250 Newton, 300 Newton, 350 Newton, 400 Newton, 450 Newton, or 500 Newton, including any value and range therebetween.

In some embodiments, the composite is characterized by compression load deflection (CLD) hardness at 50% deflection of from about 5 kPa to about 200 kPa.

In some embodiments, the composite is characterized by CLD hardness at 50% deflection of from about 10 kPa to about 150 kPa. In some embodiments, the composite is characterized by CLD hardness at 50% deflection of 10 kPa, 20 kPa, 30 kPa, 40 kPa, 50 kPa, 60 kPa, 70 kPa, 80 kPa, 90 kPa, 100 kPa, 110 kPa, 120 kPa, 130 kPa, 140 kPa, 150 kPa, 160 kPa, 170 kPa, 180 kPa, 190 kPa, or 200 kPa, including any value and range therebetween.

In some embodiments, the composite is characterized by CLD hardness at 10% deflection of from about 3 kPa to about 30 kPa. In some embodiments, the composite is characterized by CLD hardness at 10% deflection of 3 kPa, 4 kPa, 5 kPa, 6 kPa, 7 kPa, 8 kPa, 9 kPa, 10 kPa, 11 kPa, 12 kPa, 13 kPa, 14 kPa, 15 kPa, 16 kPa, 17 kPa, 18 kPa, 19 kPa, 20 kPa, 21 kPa, 22 kPa, 23 kPa, 24 kPa, 25 kPa, 26 kPa, 27 kPa, 28 kPa, 29 kPa, or 30 kPa, including any value and range therebetween.

In some embodiments, the composite is characterized by CLD hardness at 25% deflection of from about 3 kPa to about 50 kPa. In some embodiments, the composite is characterized by CLD hardness at 10% deflection of 3 kPa, 4 kPa, 5 kPa, 6 kPa, 7 kPa, 8 kPa, 9 kPa, 10 kPa, 11 kPa, 12 kPa, 13 kPa, 14 kPa, 15 kPa, 16 kPa, 17 kPa, 18 kPa, 19 kPa, 20 kPa, 21 kPa, 22 kPa, 23 kPa, 24 kPa, 25 kPa, 26 kPa, 27 kPa, 28 kPa, 29 kPa, 30 kPa, 31 kPa, 32 kPa, 33 kPa, 34 kPa, 35 kPa, 36 kPa, 37 kPa, 38 kPa, 39 kPa, 40 kPa, 41 kPa, 42 kPa, 43 kPa, 44 kPa, 45 kPa, 46 kPa, 47 kPa, 48 kPa, 49 kPa, or 50 kPa, including any value and range therebetween.

The term “compression load deflection” is known in the polymeric foam industry as a measure of the compressibility of a foam material.

In some embodiments, other elastic material, pigments for providing a desirable color, or fibers, may be combined with the matrix, such to impart different aesthetic appearances, strength or durability to the article as will be apparent to those of ordinary skill in the art.

The Article

In some embodiments, there is provided an article or a kit comprising the disclosed matrix.

In some embodiments, the article comprises a unitary form of the matrix, and/or is a disc-shaped cover or a mulch pad.

Hence, according to an aspect of some embodiments of the present invention there is provided an article (e.g., an article-of-manufacturing) or a kit comprising the disclosed composite (or matrix). The disclosed composite or matrix may be incorporated in the article in and/or on at least a portion thereof.

In some embodiments, the article is in a form such that the composite is characterized by a thickness that ranges from 0.1 cm to 20 cm, or from 0.1 cm to 10 cm along a peripheral edge of said disc or a said mulch pad. In some embodiments, the thickness of the composite varies within a range of less than ±10%.

In some embodiments, at least one surface of the article is configured to contact a surface of a substrate as described hereinabove, e.g., soil around an object. In some embodiments, the object is a plant, as described hereinthroughout.

Non-limiting examples of desired substrate's surface are an area of a plant, soil or other potting material. Potting material may include, without limitation, soil, rocks, moss, mulch or other material used in potting plants.

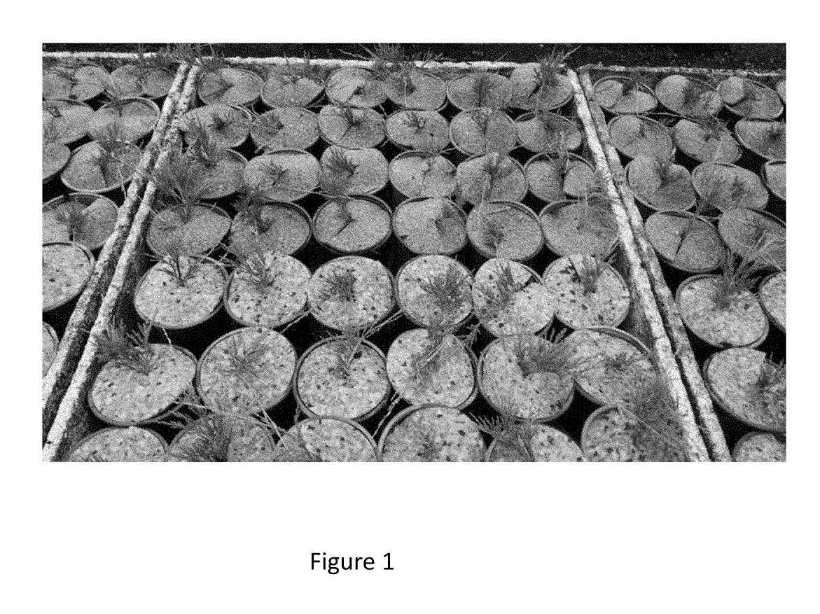

In some embodiments, the disclosed article is selected from, but is not limited to, a mat, a planting pot coverage disc (referred to hereinthroughout, for simplicity, as: “cover”, or “disc”, see FIG. 1), a plug, or a mulch pad.

In some embodiments, the disclosed article eliminates or prevents weeds growing.

In some embodiments, the disclosed article allows both permeability of air and the pass and retention of moisture for later use by the plant with which the article is associated.

In some embodiments, the disclosed article may serve as both an active and a passive nutrient source for the plant e.g., by releasing captured nutrient(s), or by leaching thereof through the soil.

In some embodiments, when used around e.g., a tree or on soil, the article may prevent grass and weed growth beneath, or around the trunk, thus, for example, making it unnecessary to trim or mow closely thereto.

At the same time, the article may provide a relatively inexpensive, natural appearing mulch system with little, if any, continuing maintenance needed. The article may prevent weed and grass growth, while passing moisture and air to underlying root systems. At the same time, the article may thermally insulate the underlying root systems.

In some embodiments, the terms “prevent”, or “eliminate”, or any grammatical derivative thereof, in the context of controlling weed growth, indicate that the growth rate of the weed is essentially nullified, or is reduced by at least 20%, at least 30%, at least 40%, at least 50%, at least 60%, at least 70%, at least 80%, or at least 90%, including any value therebetween, of the appearance of the weed beneath the disclosed cover compared to a situation lacking the presence or the use of the article (e.g., cover).

At the same time, the article may transmit moisture and air to the root system, both facilitating its nourishment while thermally insulating it.

In some embodiments, the presence of the disclosed cover (e.g., having a thickness of 0.5 cm to 1 cm) on a top of a soil provides thermal insulation. In some embodiments, by “thermal insulation” it means that the temperature of the soil covered by the disclosed cover is lower by 1° C. to 30° C., e.g., from 5° C. to 10° C. (measured at an outside air temperature of 25° C. to 40° C., e.g., about 30° C.), compared to a soil lacking the presence the cover. In some embodiments, by “thermal insulation” it means lowering the temperature of the soil by 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., or 30° C., including any value and range therebetween, compared to a situation lacking the presence or the use of the cover. Further embodiments of thermal insulation and the condition of its measurement are described in the Examples section below.

In some embodiments, lowering the temperature of the soil may be further affected the wetness degree of the disclosed cover.

In some embodiments, the term “weed” refers to undesirable perennial, biennial and/or annual plants, including broadleaf and grassy species. In some embodiments, when the disclosed article is used as soil cover, the covering zones provide an adequately light-impenetrable structure, which can prevent the growth of weeds.

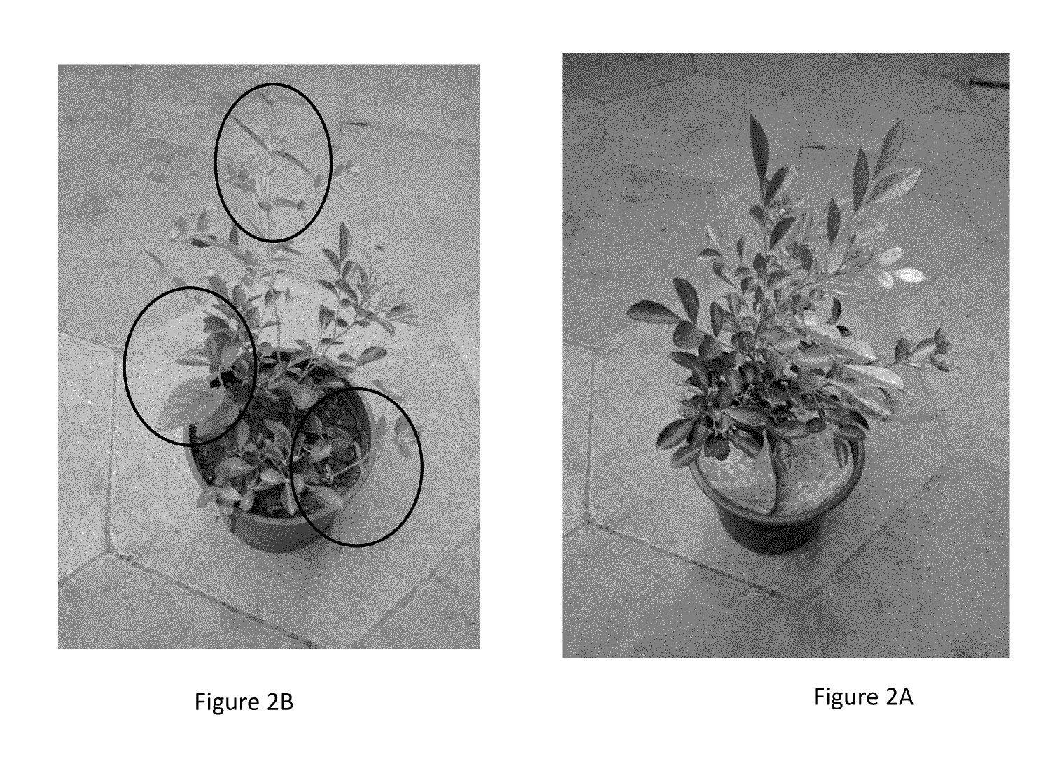

Reference is now made to FIGS. 2A-B presenting images showing a comparison of weeds presence with and without the disclosed cover.

In some embodiments, the controlling of weeds growing, using the disclosed cover may allow increasing the plant growth rate e.g., by at least 10%, at least 20%, at least 30%, at least 40%, or at least 50% compared to a situation lacking the presence or the use of the article.

In some embodiments, preventing weed and grass growth allows better utilization of nutrients of the plant from soil, since, without being bound by any particular mechanism, there is no interspecific competition for resources, and therefore lower quantity of fertilizer may be applied for the desired plant growth or propagation.

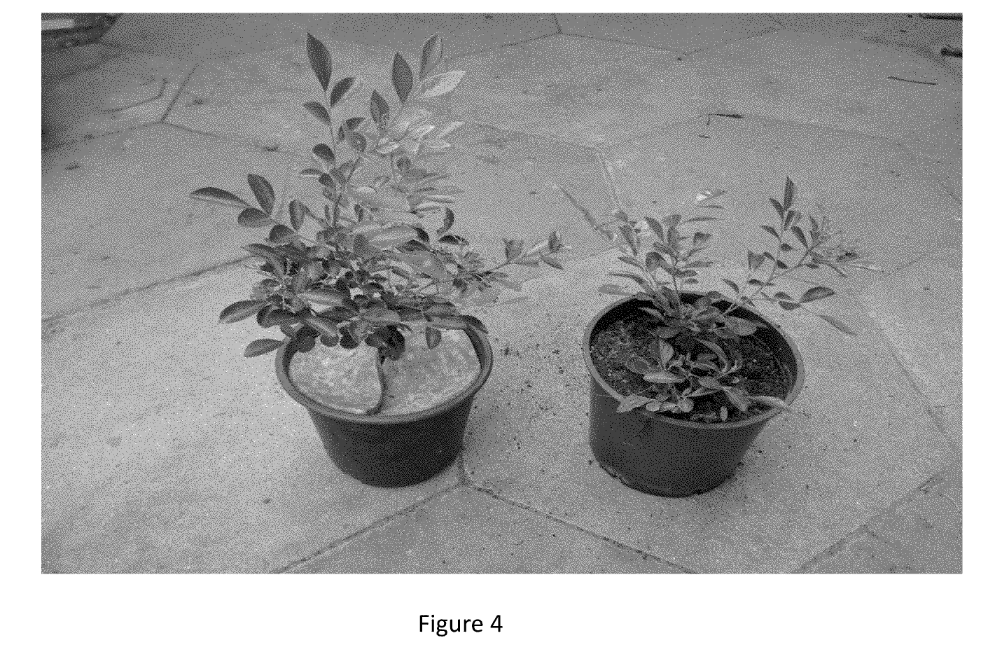

Reference is now made to FIG. 4 presenting an image showing the difference in plant growth rate with and without the disclosed cover.

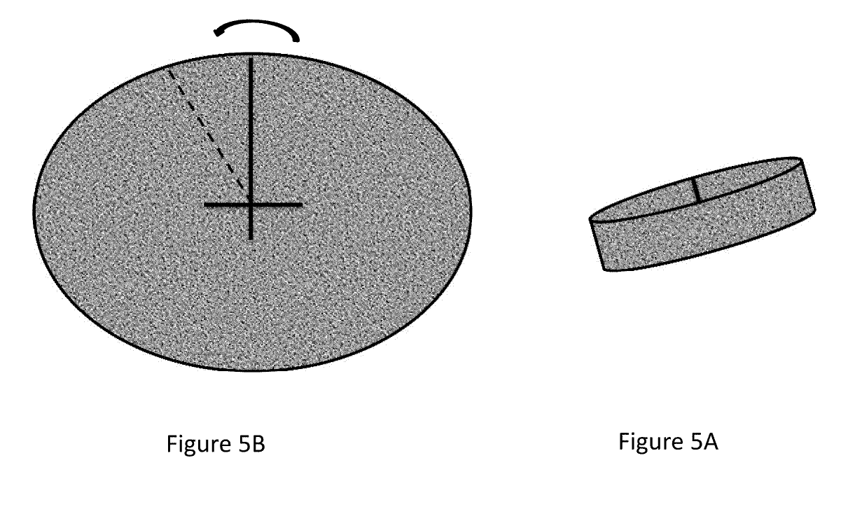

Reference is further made to FIGS. 5A-B which present schemes (side view, FIG. 5A; and top view, FIG. 5B) of the disclosed cover, in some embodiments thereof, having a notch or a cut. The cut (FIG. 5B, full line) allows one region of the disc to overlay another region of the disc, thereby providing a controllable thickness and density of the cover; dotted line points the position of the overlay layer, being relocated in the direction relative to the original position, as marked by the arrow.

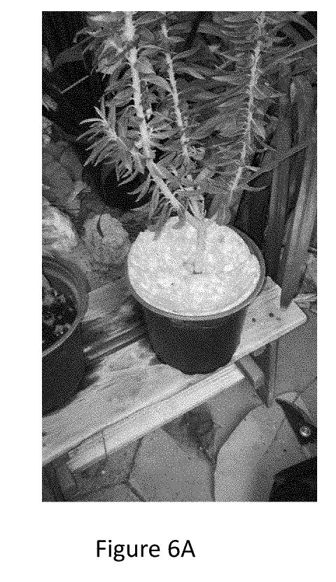

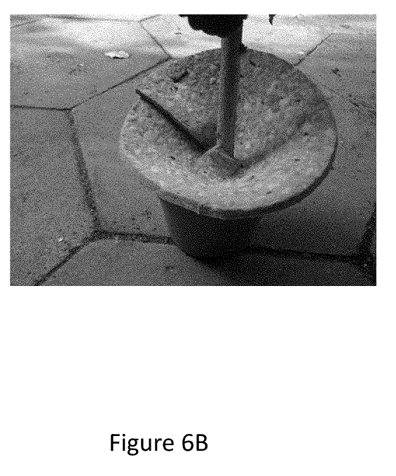

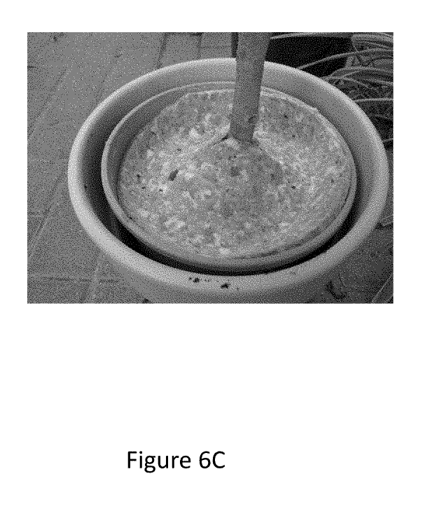

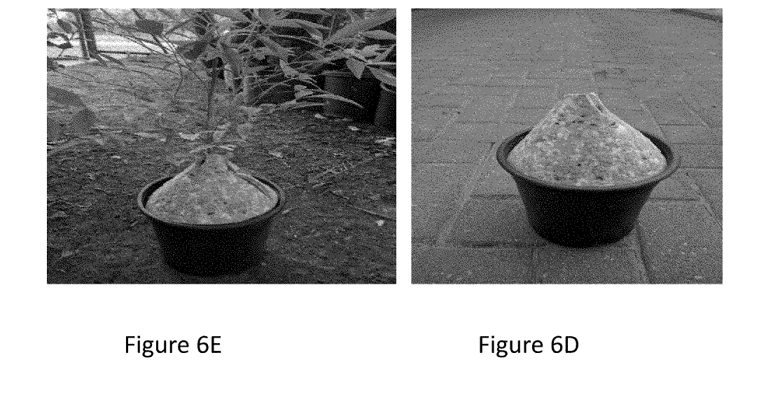

In some embodiments, the article (e.g., a cover) comprises a central opening adapted to surround a plant when the article is attached to (or is placed on, or covers) the soil surface area of the potted plant (e.g., potted plant, as shown in FIGS. 6A-E).

In some embodiments, eliminating the growth of weeds and grass adjacent to trees and plants allows eliminating a potential damage, or the necessity of close mowing or trimming to the plants and to the trees.

In some embodiments, the article may be disposed around a tree trunk. Thereafter, the article edges may be rejoined to provide a trunk-surrounding cover.

In some embodiments, the article comprising the disclosed composite, matrix, or article is in the form of disc or the mulch pad and is characterized by a thickness that ranges from 0.1 cm to 10 cm along a peripheral edge of the disc or the mulch pad, wherein the thickness varies within a range of less than ±10%.

It is also to be understood that any geometric shape of the disclosed article (e.g., cover) such as square (e.g., rectangle), or circle, may be contemplated.

In some embodiments, the article (e.g., in the form of a cover) further comprises a radial cut (or notch), extended through the thickness of the composite or matrix.

In some embodiments, the notch is in the form of a radial cut extended through the thickness of the matrix, configured to decrease the circumference of the article.

In some embodiments, the article (e.g., disc shaped cover) is partially and radially torn or cut. The cut may extend radially from the edge to the central portion of the article.

In some embodiments, the cut is configured to decrease the circumference of the article. In some embodiments, the circumference is dynamically adaptable, allowing to provide adjustable cover (e.g., disc-shaped cover).

In some embodiments, by “dynamically adaptable”, it is meant that the circumference may be decreased up to e.g., 10%, 20%, 30%, 40%, 50%, 60%, 70%, 80%, or 90%, relative to the radius in the original configuration.

In some embodiments, the adjustable cover allows mechanical flexibility such that one side of the cut may overlay the other side of the cut.

In some embodiments of the adjustable cover, in use, one side of the cut (a region of the cover) partially overlays the other side of the cut. In some embodiments, by “partially overlays” it means that the overlay layer extends or covers 1%, 5%, 10%, 15%, 20%, 25%, 30%, 35%, 40%, 45%, 50%, 55%, 60%, 65%, 70%, 75%, 80%, 85%, 90%, 95%, or even 100%, including any value therebetween, of the other side of the cut.

In some embodiments, the article (e.g., cover) has a plurality of holes. In some embodiments, by “a plurality of holes” it is meant to refer to perforation lines spaced successively within the article. In some embodiments, the plurality of holes may allow to incorporate therewith a drip irrigation line without substantially affecting the property of light transmittance blocking.

In some embodiments, the article (e.g., cover) is in a shape configured to cover a pipe or a tube, e.g., drip irrigation line. In some embodiments, the article's properties, e.g., the light transmittance blocking, are substantially not affected by its shape.

In some embodiments, the disclosed article (e.g., a cover in the form of a disc) is configured to be at least partially penetrated to a protruding member (e.g., drip irrigation line).

In some embodiments, e.g., due to the elasticity of the disclosed composite, the article sealably coats a proximal portion of the protruding member, thereby allowing to prevent e.g., a penetration of light and/or fluid between the proximal side and/or the distal sides of the protruding member.

In some embodiments, the article may have, or be adjacent to, a sensor e.g., a thermal sensor or a water/air flow sensor.

As described in the Examples section that follows the structural-flexibility of the adjustable article allows controlling parameters such as air or water transfer onto/into a covered soil.

In some embodiments, the cover (also referred to as: “adjustable article”) comprises a cut formed in its distal end, allowing deforming the cover from a disc shape to a cone shape e.g., bowl shape cone (see FIGS. 6A-E). In some embodiments, the cover has a generally circular periphery and is characterized by convex outer surface, as viewed in cross-section, with the outer surface and the inner surface being opposing surfaces.

In some embodiments, the cut allows deforming a disc shape to any desired 3D shape.

In some embodiments, the cut allows deforming a disc shape to a concave shape. In some embodiments, the adjustable disc-shaped cover may be shaped to cover a sufficient portion of various types of plants selected from, for example, cucurbitaceae (e.g., a cucumber) and ground planted trees.

Further non-limiting examples of plants include cultivated plants, such as cereals, e.g., wheat, rye, barley, triticale, oats or rice; beet, e.g., sugar beet or fodder beet; fruits, such as pomes, stone fruits or soft fruits, e.g., apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; sweet leaf (also called Stevia); natural rubber plants or horticultural or ornamental and forestry plants, such as flowers, shrubs, broad-leaved trees or evergreens, e.g., conifers; including the plant propagation material, such as seeds.

In some embodiments, in use, the article may be disposed around a tree trunk.

It will also be appreciated that the article may provide erosion protection for the underlying soil and root system. For example, even a high velocity stream of water directed against the cover will, by the time the water travels through the cover, be broken down into low velocity droplets. This serves to disperse fluid energy, and prevents soil erosion while the article does not mechanically degenerate and remains in place, thereby reducing maintenance concerns.

In some embodiments, not only does the disclosed article transform high velocity water streams into a plurality of dispersed water droplets, but it will be appreciated that the article may disperse the water laterally through the article for greater overall moisture coverage.

Composites and matrices as described herein can be incorporated within any of the articles-of-manufacturing, during manufacture of any of the article described herein.

In some embodiments, the disclosed article is identified for use, by print, by an instruction sheet, or by a label for weed growth control.

General

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, e.g., substantially ameliorating aesthetical symptoms of a condition or substantially preventing the appearance of aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Materials

Tow component adhesive, Methylene diphenyl diisocyanate (MDI) and Poly (phenyl isocyanate)-co-formaldehyde were obtained from Dow Chemicals, or BASF.

Polyurethane was obtained from Polyurethane Haifa.

Polyols: The reacting species required to produce polyurethanes are compounds that contain polyether polyols. Materials often used for this purpose are polyether polyols, which are polymers formed from cyclic ethers. Various polyether polyols that are used include polyethylene glycol, polypropylene glycol, and polytetramethylene glycol to make flexible foams or thermoset elastomers.

The polyols were obtained from Huntsman, DOW chemical or BASF.

### Example 2

### Methods

The disclosed product is defined by 3 major characteristics:
1. The amount of adhesive (kg);
2. Variation in foam density, particle size and foam type (e.g., to achieve the effect of light transmittance), and
3. Pressure.

In exemplary procedures, PU foam particles (weighs between 14-40 kg/m³ with an average weight of ˜30 kg/m³) were chopped to an average diameter of 0.5 cm with a variation of from 0.1 to 7 cm.

Next, the particles were introduced through sprayed PU adhesive (Polyol+MDI) in a rate of ˜10% adhesive, by weight, under pressure (minimum 5 ton per m²) and steam process at 140° C. for a few minutes (8-15 minutes).

Table 1 below summarizes the amount of PU foam used in the disclosed composite (actual %).

TABLE 1

| PU foam | | | |
|---|---|---|---|
| type [kg/m³] | Min [%] | Actual [%] | Max [%] |
| 14 | 10 | 40 | 70 |
| 25 | 10 | 10 | 70 |
| 30 | 10 | 30 | 50 |
| 40 | 10 | 15 | 30 |
| 50 | 5 | 5 | 40 |

In additional exemplary procedures, post curing procedures were applied using sawing, laser or water jet, so as to obtain initial sizing and/or to finalize cutting of the product (also referred to as “cover”, or “article”, interchangeably).

### Example 3

### End Product—Physical Characteristics

The densities of the disclosed compositions were as follows:

The actual density of the particles introduced into the process were between 12 kg/m³ to 40 kg/m³.

After performing pressure and steam process, the average article density was between 40 kg/m³ to 200 kg/m³ (subjected to the compounds type, amount and process conditions).

In a typical side cut, there was at least 2 types of densities to enable the right flow.

Further characteristics of the particles and the obtained product are summarized in Table 2 below.

TABLE 2

| Property | Units | Standard | Min | Actual | Max | Comments |
|---|---|---|---|---|---|---|
| Density before | kg/m³ | ISO 845 | 12 | 14-40 | 50 | |
| process | | | | | | |
| Avg. density | kg/m³ | ISO 845 | 60 | 152 | 190 | |
| after process | | | | | | |
| Thickness | cm | | 0.3 | 0.5 | 10 | |
| single foam | % | | 0.5 | 1 | 6 | |
| coverage por- | | | | | | |
| tion | | | | | | |
| water field | % | | 200 | 300 | 450 | |
| capacity | | | | | | |
| Light | % | | 0 | 0.01 | 10 | Subjected |
| transmittance | | | | | | to thick- |
| | | | | | | ness |
| Tensile | kPa | ISO 1798 | 45 | 99.5 | 165 | |
| strength | | | | | | |
| Insulation | Δ (° C.) | | 2 | 8 | 14 | Subjected |
| | | | | | | to thick- |
| | | | | | | ness |
| CLD hardness | kPa | at 10% | 4 | 9 | 20 | |
| at % compres- | kPa | at 25% | 5 | 24 | 50 | |
| sion | kPa | at 50% | 15 | 82 | 150 | |

### Example 4

### Characterization and Performance

Anti-weed: in exemplary procedures, the product was shown to prevent germination of weed as it blocks light transmittance. In exemplary procedures the light spectroscopy test was performed according to standard ASTM D1494.

Specimens of both open cell and close cell foam were prepared in different densities. The results are shown in table 3 below.

TABLE 3

| Specimen | Thickness [cm] | Light transmittance (%) |
|---|---|---|
| 2 component 105 kg/m³ | 0.5 | 8.2 |
| 2 component 150 kg/m³ | 0.5 | 0.4 |
| 1 component 40 kg/m³ | 1 | 0.7 |
| Close cell PE based foam | 1 | 0.6 |

In additional exemplary procedures, the tested article was not affected by the sterility of the soil, and which obviates the need to use herbicides as it avoids photosynthesis in the covered areas.

In additional exemplary procedures, articles in different sizes were placed on the top of planting pot infected with juvenile weeds.

In addition, a control of non-treated planting pot was placed in the same area.

After three weeks, weeds turned white and were wilted. In the control—weeds grew up successfully.

Thermal insulation: different types of the disclosed cover (in shape and thickness) where placed on top of a black planting pot (having a diameter of 18 cm) filled with soil—for 4 h outside exposed to the sun with ambient temperature of 32° C.

The soil temperature was evaluated by a needle thermometer that had been placed to a depth of 3 cm. Trial results are shown in Table 4 below:

TABLE 4

| | Cover diameter | Temp (° C.) after | |
|---|---|---|---|
| Specimen | (cm) | 1 min in soil | ΔTemp |
| Control | exposed soil | 52.9 | 0 |
| 1 | 0.5 | 44.9 | 8 |
| 2 | 1 | 44.9 | 8 |
| 3 | 1.5 | 45.5 | 7.4 |
| 4 | 0.5 cone shape | 43.5 | 9.4 |

In exemplary procedures, the disclosed product was irrigated, and the water was hold thereon enabling reduction of few degrees of the plant environment.

The results demonstrate that presence of the disclosed cover on top of a soil provides thermal insulation (temperature reduction of between 7° C. to 10° C.).

Using a cone shape, that can also supply stability to the juvenile plant stem, provides the best results as it “locks” air inside that supplies extra insulation.

Such reduction can significantly provide the plant with improved environment for growth.

FIG. 1 presents a photographic image showing comparison of weeds presence with (FIG. 1A) and without (FIG. 1B) the use of the disclosed product.

Plant growth rate/time: in exemplary procedures, the presence of the disclosed product on top of the soil prevented the growth of weeds, preserved moisture in the soil as well as provided root system isolation (physical barrier)—which resulted in improvement of growing parameters of the desired plant.

Foliage parameters: as there is significant less competition on resources (i.e., no weeds results in more resources for the plant), the plant could grow in optimal conditions. Since foliage was well developed, there were more buds and larger coverage by the flowers. FIG. 2A-B present photographic images demonstrating the difference in plant growth rate with (FIG. 2A; right) and without (FIG. 2B; left) the coverage of the disclosed product.

Water: Water uptake savings are subjected to weather conditions. Water uptake reduction results from “surface separation” that prevents direct sun and heat and reduces evaporation.

Typically, the amount of water saving achieved upon using the disclosed product was between 5% to 25%.

Field capacity: specimens of defined types of foam in different thickness was measured (in terms of size and weight) and was placed on top of a glass funnel.

In exemplary procedures, the sides of the foam were taped to avoid leaking.

In exemplary procedures, 100 mL water was poured slowly on top of the foam, and thereafter, time was measured at different stages of the process: first drip; time of specified amount (mL) passing to a beaker, and stop dripping time.

In exemplary procedures, the weight of the specimen was measured again to evaluate the amount of water remained inside.

The results are presented in the hereinbelow in Table 5:

TABLE 5

| | | Time to | Time to | Time to | Time to | No upper | Water content |
|---|---|---|---|---|---|---|---|
| | Time to first | 50 ml | 80 ml | 90 ml | 95 ml | water | remained in the |
| | droplet(min) | (min) | (min) | (min) | (min) | (min) | foam (mL) |
| Sample 1 | 2 | 20 | 45 | 55 | 55 | 55 | 15 |
| Sample 2 | 1 | 3 | 5 | 9 | 15 | 20 | 4 |
| Open cell | 0.05 | 0.1 | 0.2 | 0.3 | 0.4 | 0.5 | 4 |
| PU foam | | | | | | | |
| Close cell | na | na | na | na | na | na | All content |
| PE foam | | | | | | | stayed above the |
| | | | | | | | specimen |

As it appears, a cover comprising open cell PU foam, even at 2 cm thickness did not hold water, and transferred all the water to the soil without any buffer effect. Therefore, the soil dried much faster. On the other hand, close cell foam does not transfer water at all and therefore is less desired.

The tested samples (dual system of open cell and adhesives, laminar structure system, and structure having different densities as described) were both permeable to water with the lower the density of the structure being more permeable. The results demonstrate that the desired product is characterized by an average density of 140-152 kg/m³.

In additional exemplary procedures, the effect of the disc on water savings, was evaluated as follows: 150 planting pots (50 of each) were tested: the disclosed disc; coco disc (made of pressed coarse coco peat); and control (no disc). The trial was conducted during the summer (average day temperature of about 31.6° C.).

The test was performed using chlorides test method (by a test kit for determination of chloride in water—“viscolor HE Chloride CL 500”) according to the vendor's instruction manual, while adjusting watering level per day.

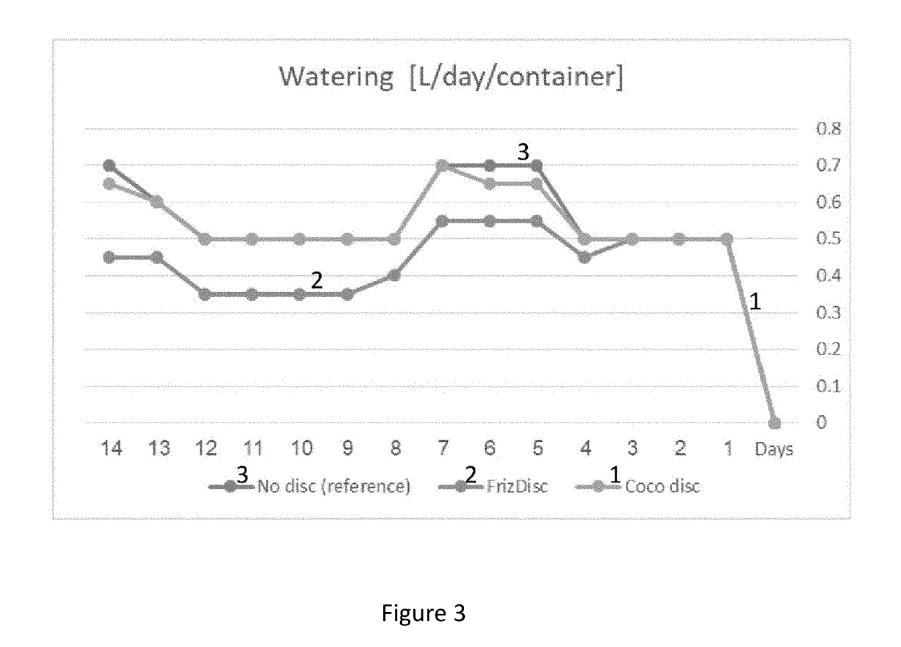

From the results, presented in FIG. 3 it can be determined that the disclosed disc (“Frizdisc”) allows reducing the amount of irrigating water each time.

Air: in exemplary procedures, no impact on air supply to the plant was found when using the disclosed cover.

It is assumed, without being bound by any particular theory, that open cell structure of the foam enables an easy path for air, providing the plant with required gases that are necessary for plant growth. In the course of movement, air tends to lose some of its thermal energy content.

Soil: without being bound by any particular mechanism, in the weeding process, there are several effects on the soil structure and content: first, weed roots takes away a portion of the soil (subjected to the worker); second, weeds tend to consume minerals and water, competing resources of the plants.

In exemplary procedures, by using the disclosed product for covering the soil, the soil is kept cool and the growth rate of the desired plants is improved (see FIG. 4).

### Example 5

### Using Various Shapes of the Cover

As can be seen in FIGS. 5A-B the notch can be easily controlled by overlapping its sides, which provides the desired thickness and density while maintaining the above-mentioned properties of preventing light penetration, and fixating to the planting pot shoulders by pressure.

Various shapes of the disclosed cover were tested (see FIGS. 6A-E).

Multi Cone Shape:

In exemplary procedures, the original cover had a larger diameter, and was deformed so as to reduce its diameter (up to 30% reduction), thereby fitting the planting pot diameter.

Upside Cone:

Several benefits were provided (relative to the original shape of the cover):

Improved thermal insulation (due to additional air volume to insulate);

Due to the elasticity of the disclosed composite a solid and strong support to the juvenile plant stem was provided, enabling the desired plant to grow vertically;

Improved control of water spread+ability to use pipe irrigation;

Improved wind protection;

Constant pressure against the planting pot walls, thereby preventing light transmittance from the side and from the notch, and

Preventing weed germination and stabilizing the product in place.

Bowl shape cone: provides good sealing and placing of the cover and water reservoir and centralization to the stem.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A matrix comprising a composite having a plurality of portions, wherein:
(a) said plurality of portions comprises a polymer selected from the group consisting of: a foamed elastomer, and a foamed rigid polymer;
(b) a binder;
(c) said composite is characterized by an average density of from 60 Kg/m³ to 180 Kg/m³, and
(d) at least two portions of said plurality of portions differ in density by at least 20 Kg/m³.

2. The matrix of claim 1, wherein said at least two portions of said plurality of portions are made of different polymers.

3. The matrix of claim 1, wherein said composite is in the form of a multi-laminar structure.

4. The matrix of claim 1, wherein said binder comprises a polymer selected from the group consisting of: polyepoxide, polyester, polyurethane (PU), a silicone adhesive, or any combination thereof.

5. The matrix of claim 4, wherein said PU comprises one or more monomeric units selected from the group consisting of: methylene diphenyl diisocyanate (MDI), toluene diisocyanate (TDI).

6. The matrix of claim 1, wherein said foamed elastomer is selected from the group consisting of: PU, cross-linked polyethylene (XPE), foamed polyethylene (PE), ethylene vinyl acetate (EVA), styrene-butadiene rubber (SBR), polyethylene terephthalate (PET), polyvinyl chloride (PVC), silicone foam, or any combination thereof.

7. The matrix of claim 1, wherein said foamed rigid polymer comprises a polymer selected from the group consisting of: polystyrene, polypropylene (PP), PE, PU, rigid PVC, or any combination thereof.

8. The matrix of claim 7, wherein said polystyrene is in the form selected from the group consisting of: expandable polystyrene (EPS), extruded polystyrene (XPS), or a combination thereof.

9. The matrix of claim 1, wherein said binder is at a concentration of about 7% to 15%, by weight of said composite.

10. The matrix of claim 1, wherein said foamed elastomer, and said foamed rigid polymer are present together at a concentration of least 60%, by weight, of said matrix.

11. The matrix of claim 1, wherein at least 60% of said foamed elastomer and said rigid polymer is in the form of open-cell foam.

12. The matrix of claim 1, further comprising one or more materials selected from the group consisting of: a pesticide, an herbicide, a fertilizer, a fungicide, a plant hormone, or any combination thereof.

13. The matrix of claim 1, wherein said composite is characterized by at least one characterization selected from: (i) light transmittance of less than 10% per cm thickness; (ii) compression load deflection (CLD) hardness at 50% deflection of from about 10 kPa to about 150 kPa, (iii) water permeability of about 0.1 to about 0.5 ml/cm/min, and (iv) tensile strength of 20 kPa to 200 kPa.

14.-16. (canceled)

17. An article or a kit comprising the matrix of claim 1.

18. The article or the kit of claim 17, configured to lower a temperature of a soil by 5° C. to 15° C., at an outside air temperature of about 25° C. to 40° C., compared to a soil lacking the presence of the article.

19. The article or the kit of claim 17, wherein said matrix is in a form selected from a unitary form of a cover or a mulch pad, or a form of rectangle- or disc-shaped cover.

20. (canceled)

21. The article or the kit of claim 19, wherein at least one surface of said cover is configured to contact soil around an object or between a plurality of objects, optionally wherein said object is a plant.

22. (canceled)

23. A method for preventing growth of grass and/or weeds, comprising providing the article of claim 18 to soil, thereby preventing growth of grass and/or weeds in said soil.

24. The article of claim 17, wherein said composite is characterized by a thickness that ranges from 0.1 cm to 10 cm along a peripheral edge of said disc or said mulch pad, wherein said thickness varies within a range of less than ±10%.

25. The article or the kit of claim 17, further comprising at least one of: (i) a radial cut extended through the thickness of said matrix, configured to decrease the circumference of said article, optionally wherein said cut allows deforming a disc-shaped cover to a cone- or concave-shaped cover; and (ii) an instruction sheet, or a label.

26.-27. (canceled)
